(19) United States
(12) Patent Application Publication
(10) Pub. No.: US 2002/0018578 A1
(43) Pub. Date: Feb. 14, 2002

(54) Bending wave loudspeaker

(76) Inventor: Paul Burton, Cambridgeshire (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/917,813

(22) Filed: Jul. 31, 2001

Related U.S. Application Data
(60) Provisional application No. 60/222,933, filed on Aug. 4, 2000.

(30) Foreign Application Priority Data
Aug. 3, 2000 (GB) 0018997.7

(51) Int. Cl. H04R 1/00; H04R 25/00

(52) U.S. Cl. 381/431; 381/152

(57) ABSTRACT

A loudspeaker and method of driving it, the loudspeaker having a panel capable of supporting bending waves, a low frequency transducer mounted to the panel for exciting bending waves in the panel at frequencies below a predetermined frequency, a high-frequency transducer mounted to the panel for exciting bending waves in the panel at frequencies above the predetermined frequency, and crossover circuitry for supplying a signal to the low-frequency transducer at frequencies below the predetermined frequency and to the high-frequency transducer for frequencies above the predetermined frequency. The predetermined frequency is substantially equal to the coincidence frequency.

This application claims the benefit of U.S. provisional Ser. No. 60/222,933, filed Aug. 4, 2000.

### TECHNICAL FIELD

The invention relates to a panel-form bending wave loudspeaker, and in particular to a panel-form bending wave loudspeaker driven by a plurality of transducers.

### BACKGROUND ART

Bending waves are transmitted on a plate with a propagation velocity that varies with frequency; the waves are dispersive. Thus there will in general be a frequency at which the speed of propagation in the plate matches the speed of propagation in free air (about 343 m/s). The actual radiation characteristic of bending waves and also the power response are different above and below the coincidence frequency, due to an increase in the coupling of the bending waves to air above coincidence. Thus, when bending waves are driven by a transducer to produce an acoustic output there will in general be an increase in the axial and overall power response of the loudspeaker above the coincidence frequency.

Moreover, at the coincidence frequency itself a wave propagating in the panel will couple to the air adjacent to the panel to produce a non-axial narrow band peak in the overall power response of the transducer which becomes superimposed on the step function described above, which causes the step to have an asymmetric shape.

Such steps and peaks in the frequency or power response of loudspeakers are particularly difficult to deal with since simple electrical compensation methods are more effective at dealing with changes in slope.

The stiffer the panel, the higher the vibrational propagation velocities and thus the lower the coincidence frequency. It is common for the coincidence frequency to lie within the audible frequency range, often in the critical mid-band frequency range where the human ear is most sensitive. Therefore, a means for dealing with the sonic effects caused by coincidence would be of real and practical benefit to designers of systems using bending wave panels as loudspeakers.

As well as disrupting an otherwise smooth power response, coincidence can cause colouration or reflections if the loudspeaker is being used in a conventional stereo or audiovisual system positioned in a typical domestic listening room. Thus the control of coincidence also has the potential to control such room colouration.

A number of methods have been used to control the effects of coincidence. One such method is that described in WO00/33612 to New Transducers Limited. Two transducers are placed at a distance apart that corresponds to half of the wavelength of sound in the panel at coincidence frequency. Therefore, at the coincidence frequency the output from the transducers will destructively interfere to reduce the peak in output at the coincidence frequency. Another approach described in the same patent application is to place two transducers less far apart but to delay the signal to one of the transducers in order that at the coincidence frequency the waves destructively interfere. However, neither of these methods deals with all of the effects of coincidence and, in particular, although they can reduce the peak at the coincidence frequency, they do not deal with the step increase in sound output above coincidence.

Anisotropic panel materials have also been suggested for control, and in such materials, where the bending stiffness is not the same for different wave propagation directions, the coincidence frequency will differ. Thus, the coincidence frequency region may be ‘smeared’ which will reduce the effect of the coincidence peak. However, the anisotropy option is not always available and in any case the effect of coincidence cannot be fully controlled.

A further approach is to use a notch filter of LCR form to reduce the overall energy output at and just above coincidence. However, this would entail a compromise being struck between a flat axial and a flat power response. An LCR notch filter is a parallel circuit of a capacitor and inductor. Normally it is damped by a parallel resistor. The whole filter of 3 parallel components is then wired in series with the load, in this case, the exciter or transducer.

Accordingly, no existing system for controlling coincidence effect is fully satisfactory.

### SUMMARY OF THE INVENTION

According to the invention, there is provided a loudspeaker comprising a panel capable of supporting bending waves, a low frequency transducer for exciting bending waves in the panel at frequencies below a predetermined frequency, a high-frequency transducer for exciting bending waves in the panel at frequencies above the predetermined frequency, and crossover circuitry for supplying a signal to the low-frequency transducer at frequencies below the predetermined frequency and to the high-frequency transducer for frequencies above the predetermined frequency, wherein the predetermined frequency is substantially equal to the coincidence frequency.

This approach is similar in one respect to that of WO97/09846 which describes the use of a low frequency transducer and a high frequency transducer. However, that earlier document does not disclose the use of a configuration for controlling coincidence in which the crossover frequency is substantially the coincidence frequency.

The crossover circuitry may comprise a low pass filter connected to the low-frequency transducer and a high pass filter connected to the high-frequency transducer.

The high pass filter may include additional attenuation to reduce the response above coincidence.

The low frequency transducer can be adapted for low frequency use, for example by including a heavier transducer capable of inputting more power into the panel. Conversely, the high-frequency transducer may be optimised for high frequency operation, for example by having a lower mass voice coil.

By dividing the frequency response at or near the coincidence frequency the drivers and the crossover circuitry may provide a large number of adjustable parameters to enable the interchange of electrical power between the low and high frequency transducers to control the overall transfer function. This is similar to the control of conventional (pistonic) loudspeakers using a crossover network to control the overall frequency and power response. Conventional loudspeakers drive multiple diaphragms using crossover networks. In the present application, a single panel radiator is driven using two separate transducers to enhance control of the output.

The placement of the high frequency transducer is less critical than that of the low-frequency transducer. Thus the low-frequency transducer can be located at a preferential location or site as taught in prior patent applications to New Transducers Limited, for example WO97/09842, and counterpart U.S. application Ser. No. 08/707,012, filed Sep. 3, 1996 (the latter being incorporated herein by reference). The high-frequency transducer preferably is placed at another location, the larger density of resonant bending wave modes at higher frequencies allowing reasonable coupling to resonant bending wave modes at a variety of transducer locations.

The high-frequency transducer may in particular be placed at or close to nodal lines of low frequency modes to minimise the coupling of the high-frequency transducer to those modes and also to reduce the effect of the high-frequency transducer on the lower resonant modes. Since the high-frequency transducer will often be the smaller transducer its location at a quieter position in terms of the lower resonant bending wave modes can improve its performance and reliability. Intermodulation effect will be ameliorated.

Another aspect of the invention involves a method of driving a panel-form loudspeaker with an input signal, the loudspeaker having a panel capable of supporting bending waves and two transducers mounted to the panel for exciting bending waves in the panel. The method comprises dividing the input signal into frequencies below a predetermined crossover frequency and frequencies above the crossover frequency, driving one of the transducers with frequencies below the crossover frequency, and driving the other transducer with frequencies above the crossover frequency, wherein the crossover frequency is substantially equal to the coincidence frequency.

### BRIEF DESCRIPTION OF THE DRAWING

Examples that embody the best mode for carrying out the invention are described in detail below and are diagrammatically illustrated in the accompanying drawing, in which:

FIG. 1 is a schematic illustration of a loudspeaker arrangement according to the invention,

FIG. 2 is a graph showing the output of a bending wave panel with no control at the coincidence frequency,

FIG. 3 is a graph showing the output of the panel of FIG. 1 in which the coincidence effect is controlled,

FIG. 4 is a graph showing the frequency response of a crossover circuit,

FIG. 5 is a schematic illustration of a crossover circuit that produces the response of FIG. 4,

FIG. 6 is a graph showing an alternative crossover response,

FIG. 7 is a graph showing a crossover response of an alternative crossover circuit including attenuation,

FIG. 8 is a schematic illustration of a crossover circuit for producing the response of FIG. 7,

FIG. 9 is a graph showing a further crossover circuit exhibiting an asymmetric response, and

FIG. 10 is a schematic illustration of a crossover circuit for producing the crossover characteristics of FIG. 9.

### DETAILED DESCRIPTION

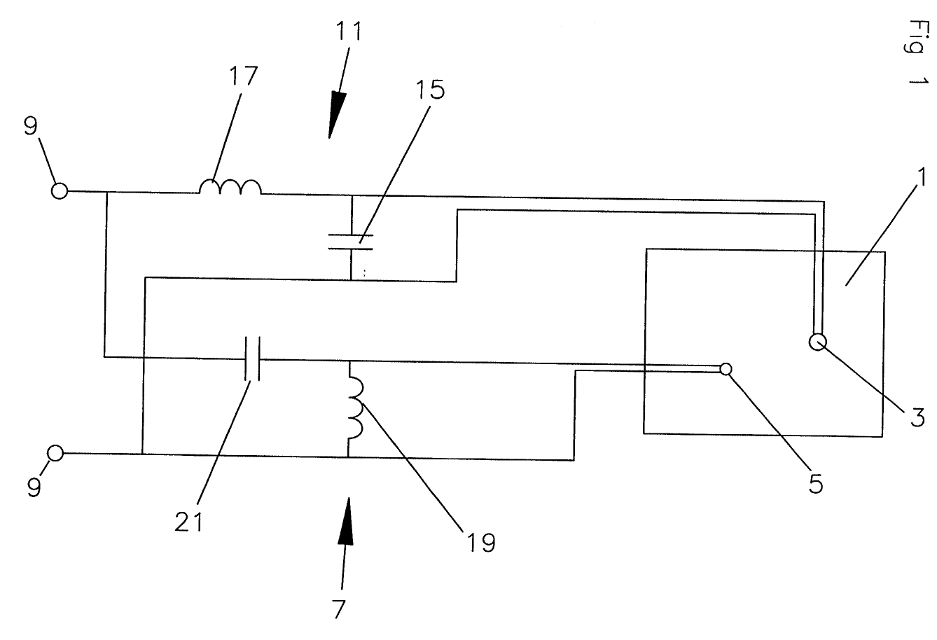

Referring to FIG. 1, a panel (1) capable of supporting resonant bending wave modes has a low-frequency transducer (3) mounted on the panel at a preferential location or site for coupling to lower frequency resonant bending wave modes, and a further transducer (5) coupled to the panel for exciting higher frequency resonant bending wave modes. Crossover circuitry (7,11) is connected to both the lower and higher frequency transducers (3,5) and a signal input at the signal terminals (9) is split by the crossover circuitry so that the frequencies below the crossover frequency of the crossover circuitry are directed to the lower frequency transducer (3) and frequency above the characteristic frequency of the crossover circuitry are connected to the high-frequency transducer (5). The crossover circuitry accordingly includes a low-pass filter (11) connected to the low-frequency transducer. The low pass filter includes an inductor (17) in series with the signal and a capacitor (15) in parallel across the signal.

Similarly, the crossover circuitry includes a high-pass filter (7) connected to the high-frequency transducer. The high-pass filter includes a capacitor (21) in series with the signal and an inductor (19) across the signal path.

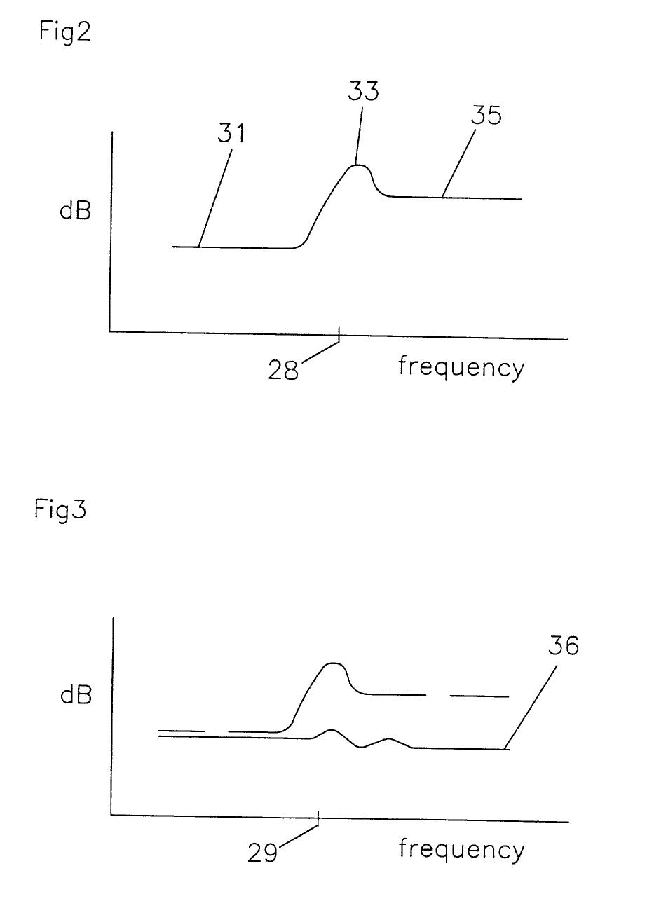

The acoustic output of the panel driven without any crossover circuitry is shown in FIG. 2. As can be seen, the sound output has a plateau (31) at lower frequencies, a peak (33) at the coincidence frequency (28) and a further plateau (35) at a higher sound level than the low frequency plateau (31) at frequencies above the coincidence frequency (28).

In order to control this response, the crossover frequency of the crossover circuitry (7,11) is arranged to be at the coincidence frequency. The crossover circuitry can be arranged to produce the sound output (36) shown in FIG. 3.

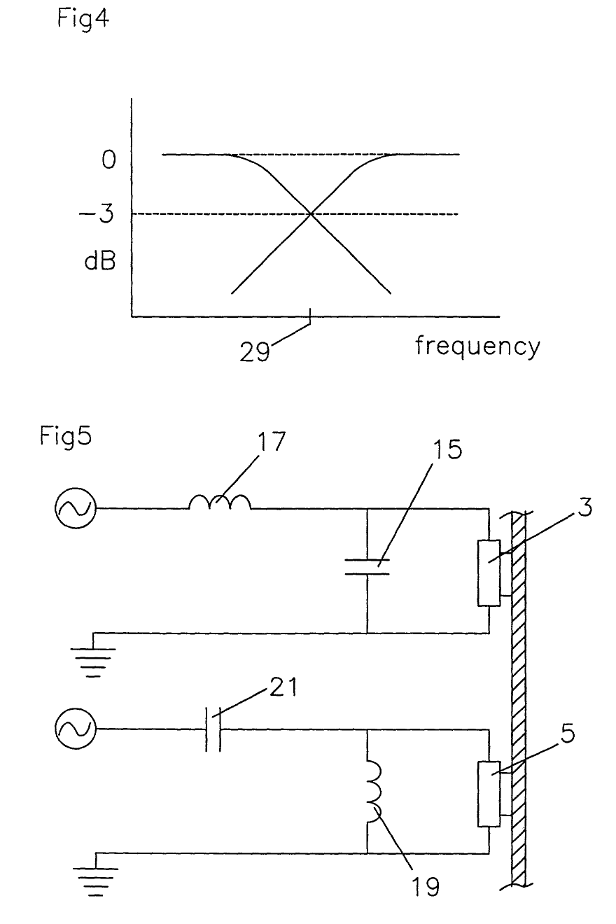

A number of examples of crossover circuitry will now be described. FIG. 4 shows one particular crossover response at which at the crossover frequency (29) each of the low-pass and high-pass filters is down 3 dB from their plateau values. Such a frequency response can be obtained with low and high-pass filters as shown in FIG. 5. The low-pass filter includes an inductor (17) in series with the signal and a capacitor (15) across the signal. The high-pass filter includes a capacitor (21) in series with the signal and an inductor (19) in parallel with the signal.

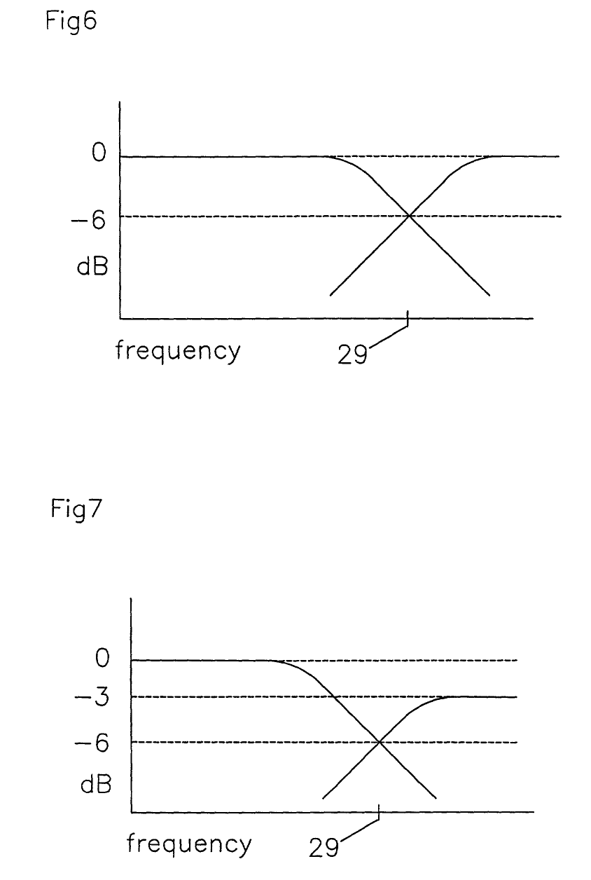

A further crossover response is shown in FIG. 6 which differs from FIG. 3 only in that the power output is down 6 dB at the crossover frequency (29). This can be achieved by using second order low and high pass filters as is known.

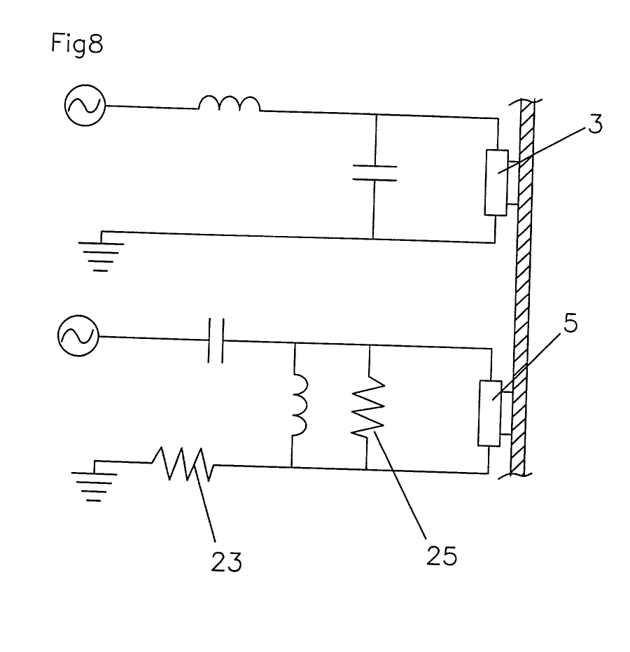

A further crossover response is shown in FIG. 7 which shows an electrical attenuation at higher frequencies. This can be achieved by adding resistors (23,25) to the high-pass filter, as shown in FIG. 8.

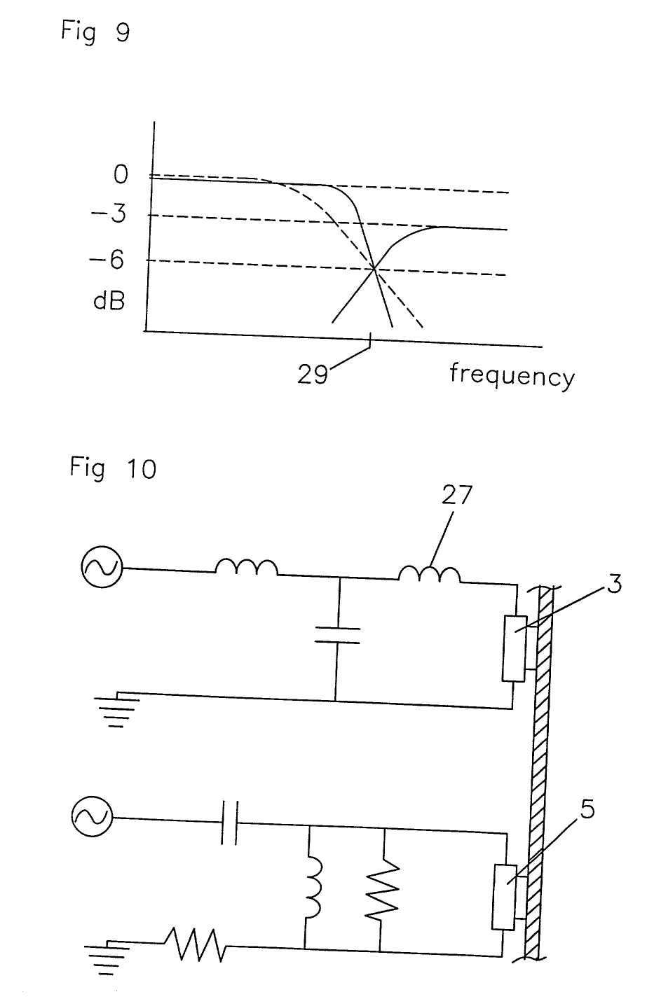

A yet further crossover response includes asymmetry in the crossover, as illustrated in FIG. 9. This may be achieved as shown in FIG. 10 by adding a further inductor (27) to the low pass filter.

The crossover frequency (29) is illustrated in each of FIGS. 3, 4, 6, 7 and 9. This crossover frequency can be arranged at or slightly above the coincidence frequency of the panel (1).

The crossover approach allows a number of advantages to be achieved. Firstly, it allows control of variations in the panel's overall axial output levels around coincidence. Secondly, it allows the increased output levels above coincidence to be attenuated if required in order to maintain a smooth power response using well known resistors, passive or active attenuation techniques.

Since the crossover circuitry may have independent low and high frequency filters they can be used to equalise an asymmetrical axial frequency or power response or a non-symmetrical peak, for example by varying the shape or order of one or both of the filters—see FIG. 10.

Each of the low and high frequency transducers can be selected to optimally perform in their range. The low frequency transducer can be large with a higher force factor (product of voice coil winding length and magnetic field) and high inductance, while the high frequency transducer can be smaller and lighter. The small voice coil diameter and low mass of the high-frequency transducer will push the drumskin panel resonance or aperture effect, which occurs in the panel material inside the voice coil parameter, to higher and less critical frequencies. Furthermore, a typically observed lift in the power response above coincidence can be cancelled by using a small and lower sensitivity transducer with the more powerful low frequency transducer.

In a distributed mode loudspeaker with a single panel driven by two transducers covering different frequency ranges separated by an electrical crossover, the low frequency transducer works in a range which is less modally dense. Its location on the panel is therefore critical to maximise the number of panel modes excited in that panel range. Its position is accordingly to be optimised to effectively drive the lowest modes for good low frequency performance. On the other hand, the panel may have a high density of bending wave modes in the higher frequency region, so the placement of the high frequency transducer allows more freedom.

The high frequency transducer may be usefully located in a low order nodal position or low frequency quiet spot, to avoid being disturbed by low frequency anti-nodal bending. This may reduce inter-modulation distortion.

Alternatively, it may be possible to locate the high frequency transducer at a nodal point at the coincidence frequency, particularly if the panel is very stiff and the coincidence frequency low. This will avoid modally driving the coincidence frequency. In this case the crossover point may be set below the coincidence frequency so that only the high frequency transducer is active at coincidence.

The techniques described assume that crossover frequency is set by the dominant coincidence frequency of the panel. This leaves transducer spacing as the main available variable to control the effects of a crossover between any drivers separated in space. Related effects are known as lobing and comb filtering. At least three approaches are possible to account for these.

Firstly, the transducers can be located less than half a wavelength apart in their overlap range.

Secondly, the transducers can be separated by several wavelengths at the crossover frequency. This will tend to de-correlate the outputs, which in conjunction with the complex modal distribution in the panel at the crossover frequency may result in good directivity and freedom from audible directionality and lobing interference notches.

Thirdly, as taught above, if the high frequency transducer is located in a null position at the coincidence/crossover frequency, it will then drive the panel less effectively at that frequency range. Then off-axis frequency response lobes and comb filtering effects are reduced in proportion to the reduced transducer coupling in this range.

The invention thus provides a simple mechanism for controlling coincidence effects in a bending wave panel speaker.

1. A loudspeaker comprising a panel capable of supporting bending waves, a low frequency transducer mounted to the panel for exciting bending waves in the panel at frequencies below a predetermined frequency, a high-frequency transducer mounted to the panel for exciting bending waves in the panel at frequencies above the predetermined frequency, and crossover circuitry for supplying a signal to the low-frequency transducer at frequencies below the predetermined frequency and to the high-frequency transducer for frequencies above the predetermined frequency, wherein said predetermined frequency is substantially equal to the coincidence frequency.

2. A loudspeaker according to claim 1, wherein the crossover circuitry comprises a low pass filter connected to the low-frequency transducer and a high pass filter connected to the high-frequency transducer.

3. A loudspeaker according to claim 2, wherein the high pass filter includes additional attenuation to reduce the response above the coincidence frequency.

4. A loudspeaker according to claim 3, wherein the high frequency transducer is a moving coil device adapted for high frequency operation by a small diameter voice coil.

5. A loudspeaker according to claim 4, wherein the high-frequency transducer is adapted for high frequency operation by a low mass voice coil.

6. A loudspeaker according to claim 5, wherein the low-frequency transducer is located at a position to effectively drive the lowest frequency modes for good low frequency performance.

7. A loudspeaker according to claim 5, wherein the high-frequency transducer is located at or close to nodal lines of low frequency modes to minimise the coupling of the high-frequency transducer to those modes and also to reduce the effect of the high-frequency transducer on the lower resonant modes.

8. A loudspeaker according to claim 1, wherein the high frequency transducer is a moving coil device adapted for high frequency operation by a small diameter voice coil.

9. A loudspeaker according to claim 8, wherein the high-frequency transducer is adapted for high frequency operation by a low mass voice coil.

10. A loudspeaker according to claim 9, wherein the high-frequency transducer is located at or close to nodal lines of low frequency modes to minimise the coupling of the high-frequency transducer to those modes and also to reduce the effect of the high-frequency transducer on the lower resonant modes.

11. A loudspeaker according to claim 1, wherein the high-frequency transducer is located at or close to nodal lines of low frequency modes to minimise the coupling of the high-frequency transducer to those modes and also to reduce the effect of the high-frequency transducer on the lower resonant modes.

12. A loudspeaker according to claim 1, wherein the crossover frequency is at or slightly above the coincidence frequency.

13. A loudspeaker according to claim 1, wherein the high frequency transducer is located at a nodal point at the coincidence frequency.

14. A loudspeaker according to claim 13, wherein the crossover frequency is below the coincidence frequency.

15. A loudspeaker according to claim 1, wherein the transducers are separated by less than half a wavelength at the crossover frequency.

16. A loudspeaker according to claim 1, wherein the transducers are separated by several wavelengths at the crossover frequency.

17. A method of driving a panel-form loudspeaker with an input signal, the loudspeaker having a panel capable of supporting bending waves and two transducers mounted to the panel for exciting bending waves in the panel, the method comprising:
dividing the input signal into frequencies below a predetermined crossover frequency and frequencies above said crossover frequency;
driving one of the transducers with frequencies below said crossover frequency; and
driving the other transducer with frequencies above said crossover frequency,
wherein said crossover frequency is substantially equal to the coincidence frequency.

18. A method according to claim 17, wherein said crossover frequency is at or slightly above the coincidence frequency.

19. A method according to claim 17, wherein the high frequency transducer is located at a nodal point at the coincidence frequency.

20. A method according to claim 19, wherein said crossover frequency is below the coincidence frequency.

21. A method according to claim 17, wherein the transducers are separated by less than half a wavelength at said crossover frequency.

22. A method according to claim 17, wherein the transducers are separated by several wavelengths at said crossover frequency.
